(19) United States
(12) Patent Application Publication
(10) Pub. No.: US 2025/0296494 A1
(43) Pub. Date: Sep. 25, 2025

(54) Modular side barrier assembly for a retractable ramp or bridge plate platform for people to access vehicles and the platform comprising it

(71) Applicant: MASATS, S.A., Sant Salvador De Guardiola (ES)

(72) Inventors: Jose BERNABEU VICEO, SANT SALVADOR DE GUARDIOLA (ES); Jordi PUJOL OLLER, SANT SALVADOR DE GUARDIOLA (ES)

(21) Appl. No.: 18/980,946

(22) Filed: Dec. 13, 2024

(30) Foreign Application Priority Data
Mar. 20, 2024 (ES) U202430543

(51) Int. Cl. B60P 1/43; A61G 3/06

(52) U.S. Cl. CPC B60P 1/431; A61G 3/061

(57) ABSTRACT

The invention relates to a modular side barrier assembly for a ramp platform for transport vehicles that is integrated below the floor in an area adjacent to a door, which extends and retracts when it moves between a resting position and an operating position. The modular assembly comprises:
a barrier support configured by way of an oblong platen
removable fastening means for fastening the barrier support to one of the side edges of the platform;
a side barrier capable of moving between a folded position, in which it does not protrude or protrudes a minimum distance from the upper face of the barrier support, allowing the platform to be concealed below the floor in the resting position, and an unfolded position, in which the side barrier protrudes a maximum distance above the upper face of the barrier support, depending on whether all or part of the side barrier has come out outside, beyond the floor edge when the platform is moved between the resting position and the platform operating position.

### TECHNICAL FIELD OF THE INVENTION

The present invention falls within the technical field of the side barriers with which some retractable ramp or bridge plate platforms are equipped for access to vehicles, particularly for public and private transport vehicles. This type of platform is assembled integrated below the floor of the vehicle in a floor edge area adjacent to a door of the vehicle, for example in a framework integrated in the floor just below the area adjacent to the door. The platform of a ramp is capable of extending and retracting as it moves between two end positions, a resting position, in which the essentially rectangular access platform is concealed inside the vehicle below the floor of the vehicle, and a platform operating position, in which the platform is arranged in an inclined plane from the floor edge of the vehicle to a surface located at a lower height level from which people access the vehicle, for example the floor of a pavement or a station platform.

The positions of the platform in the case of a bridge plate platform, which are more common in trains or trams, are similar to those of a ramp, with the difference that the platform is not inclined in the operational position, but extended at practically the same level as the floor of the vehicle, bridging the horizontal separation distance between the floor of the vehicle and the surface on which the people stand, which is practically at the same height as the floor of the vehicle.

The purpose of equipping these platforms with side barriers is to protect people walking on the ramp once the platform has reached its operational position, that is, it is fully extended and resting stably on the ground, preventing people from falling off the sides of the ramp, especially in the case of wheelchair users.

### BACKGROUND OF THE INVENTION

Nowadays most public transport vehicles such as trams, trains and buses are equipped with automatically concealable or retractable ramps to facilitate access to said vehicle for people in wheelchairs, people with reduced mobility, people pushing pushchairs, shopping trolleys, etc. Examples of ramps of this type are those described in patent document EP1121920 and in utility model document ES1075682.

In general, ramp assemblies are formed by a structure or framework that is fixedly assembled on the vehicle, or in the lower portion thereof or integrated into the floor of the vehicle, in an area adjacent to a passenger entry and exit door. A platform is provided within the framework that, when activated by the bus driver, train or tram driver or by other means, is pushed by movement transmission means from the rear portion of the framework until it comes out horizontally through the front portion, that which faces outward where the passengers are located, and inclined until the front portion of the platform rests on the surface on which the passengers are waiting. In order for the platform to move in relation to the framework, the platform and the framework are provided with bearings and guide channels. Thus, the platform can move from an end resting position, where it is confined inside the framework, without protruding from the vehicle, to an operational platform position, where the platform is arranged inclined outside the framework between the passenger waiting surface and the floor of the vehicle.

A common situation where the use of a concealable or retractable ramp is essential is in train and tram stations, where there is a considerable separation gap in the horizontal direction and especially in the vertical direction between the surface where the people wanting to access the vehicle are located, for example a station platform, and the floor of the vehicle. The platform of the ramp bridges this separating distance so that passengers can walk up it in order to access the vehicle and walk down the same in order to disembark.

It is important for the ramp platform to have safety measures for passengers when boarding and disembarking, such as handrails or protective side barriers. In fact, the Americans with Disabilities Act (ADA), states in Title 49, Transportation, Part 38.83 (c)-(4), that each side of the ramp or bridge plate shall have barriers at least 2 inches high to prevent mobility aid wheels from slipping off.

Examples of ramps provided with side barriers are described in patent documents DE102020204672, EP2730715, WO200898110 and EP2627537.

It is desirable for the side barriers to be folded so that they fit into the space provided below the floor of the vehicle intended to house the platform, as is the case for the platform with side barriers described in document EP2627537, without having to increase its height dimensions.

Another requirement is that the side barriers, once they have reached their unfolded position, should not leave said position until the barriers begin to be inserted below the floor, that is, they should have a safety mechanism that locks the unfolded position and is not released by accidental blows to the barriers during the transit of passengers.

### DESCRIPTION OF THE INVENTION

In order to provide an alternative solution, a modular side barrier assembly is disclosed for a retractable platform of a ramp or of a bridge plate for people to access vehicles, particularly to public and private transport vehicles, the platform being of the type that is assembled integrated below the floor of the vehicle in a floor edge area adjacent to a door of the vehicle, and capable of extending and retracting as it moves between two end positions, a resting position, in which the essentially rectangular platform is concealed inside the vehicle below the floor of the vehicle, and a platform operating position, in which the platform is extended arranged from the floor edge of the vehicle to a surface from which people access the vehicle.

The modular side barrier assembly object of the invention comprises:
a barrier support configured as an oblong platen, the support comprising an upper face, a lower face, an outer side face, an inner side face, a front face and a rear face;
removable fastening means for fastening the removable fastening of the barrier support to one of the side edges of the platform;
a side barrier capable of moving between two end positions, a folded position, in which the side barrier does not protrude or protrudes a minimum distance from the upper face of the barrier support, said minimum distance being such that it allows the platform to be concealed below the floor of the vehicle in the resting position of the platform, and an unfolded position, in which the side barrier protrudes a maximum distance above the upper face of the barrier support, said maximum distance being greater than the minimum distance, depending on whether all or part of the side barrier has come out outside, beyond the floor edge when the platform is moved between the resting position and the platform operating position.

According to a preferred embodiment of the modular side barrier assembly of the invention, the removable fastening means are at least two screws and the barrier support is provided with at least two corresponding holes for the passage therethrough of the two screws with which the support is fastened to one of the side edges of the platform.

According to another feature of the modular side barrier assembly of the invention, the side barrier forms a hinged parallelogram structure together with the outer side face of the support, the side barrier comprising a main bar, arranged parallel to the outer side face of the support, and at least two arms, arranged parallel to each other, each arm having a first joint with the main bar and a second joint with the outer side face of the support. In the unfolded position of the side barrier, the main bar is located above the upper face of the barrier support and the at least two arms are arranged in a direction perpendicular to the main bar, and in the folded position of the side barrier the at least two arms are arranged in a direction almost parallel to the main bar, folded with respect to the outer side face of the support. In the folded position, the main bar is arranged flush with the upper face of the support or separated by a minimum distance.

In accordance with another feature of the modular side barrier assembly of the invention, the side barrier comprises a biasing means by which the side barrier is biased to its unfolded position. This biasing means can act directly on the main bar of the barrier, or indirectly, for example by acting on one of the arms hinged to the main bar.

According to the preferred embodiment of the modular side barrier assembly of the invention, the biasing means comprises a traction spring or a push strap.

According to another feature of the preferred embodiment of the modular side barrier assembly of the invention, the side barrier comprises a third arm located between the first and second arms, arranged parallel thereto and provided with a first joint with the main bar and a second joint with the outer side face of the support.

In accordance with another feature of the preferred embodiment of the modular side barrier assembly of the invention, the third arm extends in an appendage beyond its hinge on the outer side face of the support. Between the appendage and a point on the outer side face of the support there is arranged a biasing means whereby the side barrier is biased to its unfolded position via the third arm.

According to another feature of the modular side barrier assembly of the invention, the side barrier comprises respective hinge shafts by which the arms of the side barrier are hinged to the main bar, and preferably, a respective wheel is arranged at one end of each hinge shaft, the contour of which protrudes from the upper edge of the main bar. According to the preferred embodiment of the modular side barrier assembly of the invention, the wheels are made of an anti-friction material so that while the platform with the folded side barriers is moved below the floor of the vehicle while the platform is extended or retracted, with the main bar biased by the biasing means whereby it tends to reach a raised position which is limited by the bottom of floor of the vehicle flooring while it travels inside the floor, no friction is generated by the wheels against the lower surface of said floor and the wheels roll on said surface.

Advantageously, a second preferred embodiment of the modular side barrier assembly of the invention is disclosed, wherein the side barrier further comprises a locking device for locking the side barrier in the unfolded position when the side barrier is completely outside the interior of the vehicle, and unlocking it to initiate its folding when it begins to be inserted into the interior of the vehicle.

According to this second preferred embodiment of the modular side barrier assembly of the invention incorporating a locking device, the locking device comprises:
a locking platen hinged to the hinge shaft with the side barrier of the first arm which is arranged closest to the rear face of the support, said first arm being hinged at the rear end of the main bar, the locking platen being arranged between the plane in which the first arm moves and the plane of the outer side face of the support, the locking platen being provided with a slot mainly configured with a path of a concentric circular arc with respect to the centre of the hinge of the first arm with the outer side face of the support and the end of the slot extending furthest from the hinge of the first arm with the main bar in a locking section protruding from the remainder of the path of the slot in a direction away from the articulation of the first arm with the outer side face of the support;
a pivot protruding from the outer face of the support in a direction perpendicular thereto, the pivot being arranged inside the slot, configured such that when the pivot is inside the locking section of the slot, the side barrier is in the locking position in which the side barrier is locked in its unfolded position;
a locking biasing means attached on the one hand to the first arm and on the other hand to the locking platen that it biases so that the locking platen is in the position where the pivot is inside the locking section of the slot.

According to another feature of the second preferred embodiment of the modular side barrier assembly of the invention, the locking platen has an unlocking edge located opposite the edge of the locking platen which is closest to the locking section of the slot, and that in the locked position, where the side barrier is locked in its unfolded position, the unlocking edge protrudes from behind the first arm extending in the direction towards the rear face of the support, the unlocking edge being on one side of the first arm and the pivot on the opposite side of the first arm in said locking position. The locking biasing means is configured so that by exerting a certain force on the unlocking edge, the locking biasing means allows the locking platen to rotate about the hinge shaft of the first arm with the side barrier to an unlocked unfolded position of the side barrier where the pivot is outside the locking section of the slot.

Preferably, in the second preferred embodiment of the modular side barrier assembly of the invention, the locking biasing means is a strap attached at one end to a portion of the first arm located in the vicinity of the articulation of said first arm with the main bar, and attached at the other end thereof to the locking platen at a portion located in the vicinity of the end of the slot extending into the locking section.

In accordance with another feature of the second preferred embodiment of the modular side barrier assembly of the invention, the unlocking edge is located in an area of the locking platen that is likely to strike against the floor edge of the vehicle below which the platform is installed, when the rear edge of the platform begins to be inserted below the floor as it leaves the platform operating position and moves towards the resting position.

Preferably, the locking biasing means is configured so that the value of the force that enables unlocking is at least the value of the thrust that the unlocking edge receives from the floor edge of the vehicle when the rear edge of the platform begins to be inserted below the floor as it leaves the platform operating position and moves towards the resting position.

According to a second aspect of the invention, a retractable platform of a ramp or of a bridge plate for people to access vehicles, particularly to public and private transport vehicles, is disclosed, the platform being of the type that is assembled integrated below the floor of the vehicle in a floor edge area adjacent to a door of the vehicle, and capable of extending and retracting as it moves between two end positions, a resting position, in which the essentially rectangular platform is concealed inside the vehicle below the floor of the vehicle, and a platform operating position, in which the platform is extended from the floor edge of the vehicle to the floor of the vehicle, in which the essentially rectangular platform is concealed within the vehicle beneath the floor of the vehicle, and a platform operating position, where the platform is extended arranged from the floor edge of the vehicle to a surface from which people access the vehicle, the platform being characterised in that a modular side barrier assembly as described above is assembled on at least one of the two side edges of the platform.

### BRIEF DESCRIPTION OF THE DRAWINGS

The attached drawings illustrate, by way of non-limiting example, a preferred embodiment of the modular side barrier assembly object of the invention shown in isolation or assembled on a platform, in this case belonging to a ramp. In said drawings:

FIG. 1 is a perspective view of a platform of a ramp belonging to the state of the art, provided with side barriers that deploy with the express intervention of a user;

FIG. 2 is a perspective view of a platform of a ramp provided on one of the side edges of the platform of the modular side barrier assembly object of the invention, the side barrier being shown in an unfolded position;

FIGS. 3 and 4 are perspective and detail views of the side edge of the platform of the ramp in FIG. 2 on which the modular side barrier assembly subject of the invention is assembled, with the side barrier respectively in an unfolded position and in a folded position;

FIGS. 5 and 6 are perspective views of the isolated modular side barrier assembly shown in FIG. 3;

FIG. 7 is an enlarged view of the locking device of the modular side barrier assembly shown in FIG. 7;

FIGS. 8a to 8e depict a ramp provided with the modular side barrier assembly shown in FIGS. 5 and 6 in the successive positions adopted by the platform and the side barrier when the platform moves from the resting position to the platform operating position;

FIG. 9 shows another perspective view of the side edge of the platform of the ramp of FIG. 4, seen from below the platform;

FIG. 10 is an enlarged view of detail C of FIG. 9 of the locking device, parts of the components not visible from the outside being shown in dashed lines in order to better appreciate the depth or thickness of the components, wherein the strap constituting the locking biasing means is shown in an exploded position relative to the locking platen;

FIG. 11 is another enlarged view of detail C of FIG. 9;

FIG. 12 is a perspective view of a portion of the ramp platform shown in FIG. 8e, wherein the side barrier is in an unfolded position and locked in said position;

FIG. 13 is an enlarged view of detail D showing the locking device of FIG. 12, but corresponding to an unfolded barrier position and in the non-locking position;

FIG. 14 is an enlarged view of detail D of FIG. 12 wherein the side barrier is in an unfolded position and in a locking position; and

FIGS. 15a to 15d are perspective views of the side edge of the platform of the ramp shown in FIGS. 8b to 8e, in which the biasing means by which the side barrier is biased to its unfolded position is partially shown schematically represented by a dashed line at the end by which it is attached to the appendage of the third arm, in order to see more clearly the position adopted by the appendage of the third arm at each stage.

### DETAILED DESCRIPTION OF THE DRAWINGS

FIG. 1 shows a known ramp 1′ and framework 8 assembly, an essentially rectangular platform 11 forming part of the ramp 1′, which is retractable and suitable for people to access vehicles, particularly public and also private transport vehicles. The platform 11 of the ramp 1′ is assembled integrated into the floor of the vehicle in a floor edge area 9 adjacent to a door of the vehicle. In particular, the ramp 1′ and framework 8 assembly is assembled integrated into the floor of the vehicle and the framework 8 is assembled flush at the top therewith in an area adjacent to a door of the vehicle. The platform 11 for people to access the vehicle moves in and out of the framework 8, and is capable of adopting two end positions:
a resting position, where the access platform 11 is concealed inside the vehicle, and
a platform operating position, depicted in FIG. 1 wherein the platform 11 is arranged on an inclined plane from the floor of the vehicle to a surface located at a lower height level from which people access the vehicle.

At this point it must be noted that a bridge plate of the type assembled on trains or trams also comprises a platform 11 that is very similar to that described for ramp 1′, with the difference that in the platform operating position, instead of the platform being arranged on an inclined plane, the platform 11 is extended without inclination, parallel to the plane of the floor of the vehicle, arranged extending from the floor edge 9 of the vehicle to a surface at essentially the same height as the floor from which people access the vehicle. That is, in the platform operating position of a bridge plate, the front edge 15 of the platform 11 is at the same height level as the rear edge 16 of the platform 11, which in turn is flush with the floor of the vehicle. Except for the detail that in the operating position of the platform 11 of a bridge plate the platform 11 is not inclined, but in a horizontal plane, the rest of the features described below for the ramp 1 platform 11 are applicable to the platform 11 of a bridge plate.

In fact, whether it is a platform 11 of a ramp 1 or the platform 11 of a bridge plate, in the platform operating position, the platform 11 is extended arranged from the floor edge 9 of the vehicle to a surface from which people access the vehicle (said surface being able to be at the same height level or at a lower level than the floor of the vehicle).

In the platform 11 for people to access the vehicle, a front side 15 can be identified, which is that which rests on the surface on which the people wishing to access the vehicle are located, a rear side 16, which is the closest to the floor of the vehicle in the operative ramp position, and two lateral sides 13 and 14, can be identified.

As indicated above, the framework 8 is capable of being assembled in a fixed manner, integrated into the floor of the vehicle and flush at the top therewith in an area adjacent to a door of the vehicle, and its dimensions are suitable for housing the platform 11 inside the same. The framework 8 is provided with an oblong front opening 84, extending in a direction parallel to the rear side 16 of the platform 11, for passage therethrough of the platform 11 when moving from one end position to the other, for movement and lower support of the platform 11 as the platform 11 moves inside and with respect to the framework 8. The frame 8 is preferably formed of four profiles that make up a frame in the horizontal plane, with sides essentially parallel to those of the platform 11, which serve to attach the other components of the framework 8. Furthermore, as can be seen in FIG. 1, the framework 8 comprises:
an essentially flat front frame 82 arranged in a plane perpendicular to that of the floor of the vehicle, which configures the oblong front opening 84 configured to be passed through by the platform 11 when passing from one end position to the other,
an essentially flat and rectangular upper cover 90 intended to be flush with the bottom of the floor of the vehicle and with dimensions such that the movement transmission means and the platform 11 are concealed below the upper cover 90 when the platform 11 is in the resting position. The upper cover 90 is configured by way of a hatch for the inspection of the components of the ramp 1′ arranged below the same and to provide access for the maintenance thereof, and
an elongate threshold part 91, arranged adjacent to the upper cover 90, contained in a plane perpendicular to that of the front frame 82 and arranged attached or coupled to said front frame 82.

The ramp 1′ in FIG. 1 comprises manually deployable protective side barriers 7 coupled to the lateral sides 13, 14 of the platform 11, consisting of flat rectangular portions configured as levers the fulcrums of which correspond to axes of rotation arranged along the lateral sides 13, 14 of the platform 11. The manually deployable protective side barriers 7 are capable of moving from a non-protective position, in which the manually deployable protective side barriers 7 are folded down on the platform 11, to a protective position, in which the manually deployable protective side barriers 7 are oriented in a plane essentially perpendicular to the platform 11, by stepping on the corresponding outermost lever arms of the platform 11 with the foot. FIG. 1 shows how the lateral margins of the platform 11 comprise recessed areas that provide housing for the manually deployable protective side barriers 7 so that, when they are folded down on the platform 11, they are flush with the rest of the upper surface of the platform 11. These manually deployable protective side barriers 7 comprise polymer stops to prevent any damage in case of impact with the barriers, for example if the platform 11 is ordered to return inside the framework 8 and the side barriers have been left open (if the person in charge forgets to close them manually or with their foot). In addition, the front side 15 of the platform 11 is equipped, on the edge thereof, with a sacrifice piece, made of a technical polymer material, which is easy to replace.

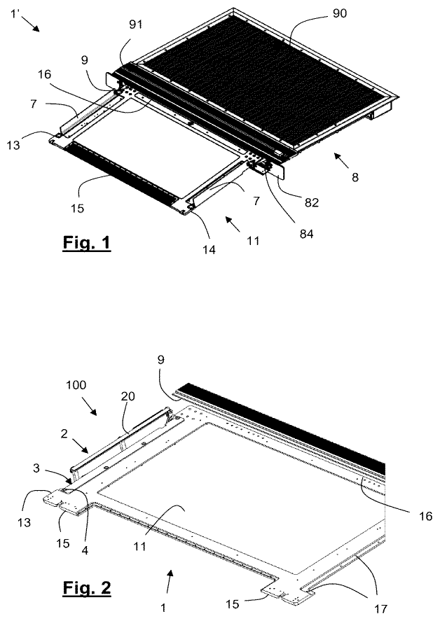

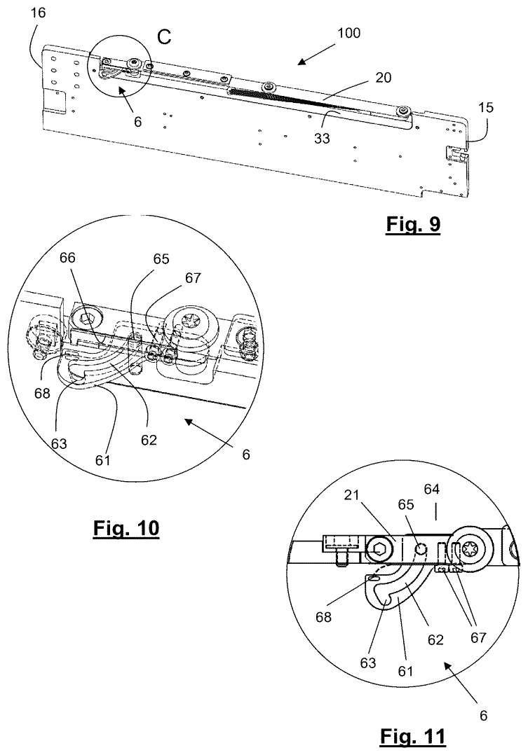

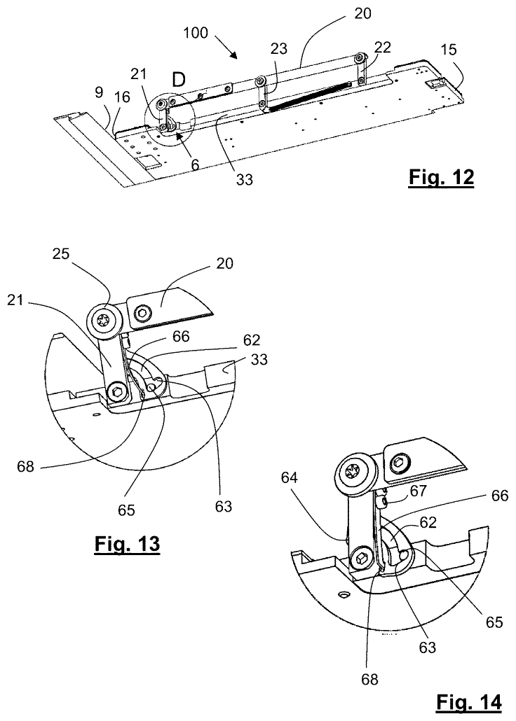

In FIGS. 2 to 15 a ramp 1 is shown in which a modular side barrier 2 assembly 100 is assembled on at least one of the two side edges 13, 14 thereof of the platform 11. Specifically, the drawings show the modular assembly 100 assembled on the side edge 13.

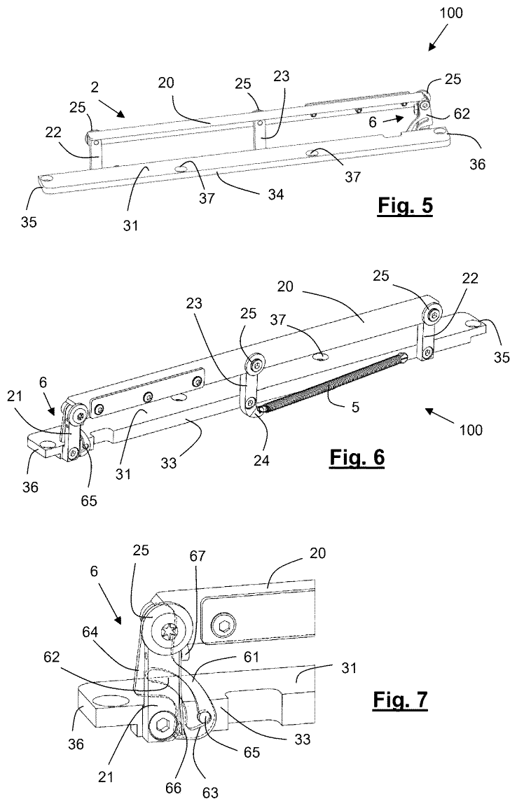

The modular assembly 100 is shown in isolation in FIGS. 5 and 6, that is, removed from the side edge 13 of platform 11 of the ramp 1. As can be seen, the modular side barrier 2 assembly 100 comprises a barrier support 3, a removable fastening means 4 and a side barrier 2.

The barrier support 3 is configured as an oblong platen, in which an upper face 31, a lower face 32, an outer side face 33, an inner side face 34, a front face 35 and a rear face 36 are distinguished. The inner side face 34 is that which, when the modular assembly 100 is positioned on the side edge 13 of the platform 11, faces the side edge 13 adjacent thereto, while the outer side face 33 is that which is visible from the outside once the modular assembly 100 is assembled. The thickness of the support 3, measured as the perpendicular distance between the lower face 32 and the upper face 31, is for the most part preferably similar to the thickness of the platform 11 of the ramp 1 or slightly greater (1 mm more) so that the upper face 31 of the support 3 is almost flush with the upper surface of the platform 11 and that the support 3 also does not protrude below the lower surface of the platform 11. In fact, the support 3 is assembled in recessed areas 17 (see FIGS. 2 and 4) of the side edges 13 and 14, in order to rest the support 3 on said areas and to removably fasten it by means of the removable fastening means 4. The removable fastening means 4 are four screws that are screwed into these recessed areas 17 of the side edges 13 and 14 by inserting them through the through holes 37.

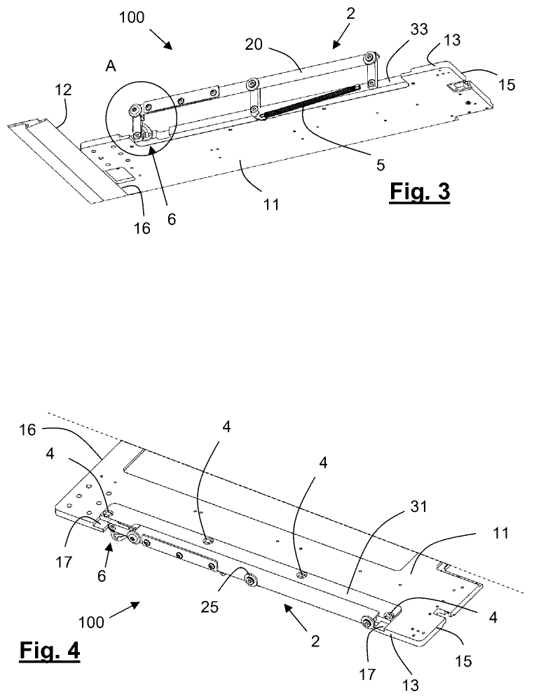

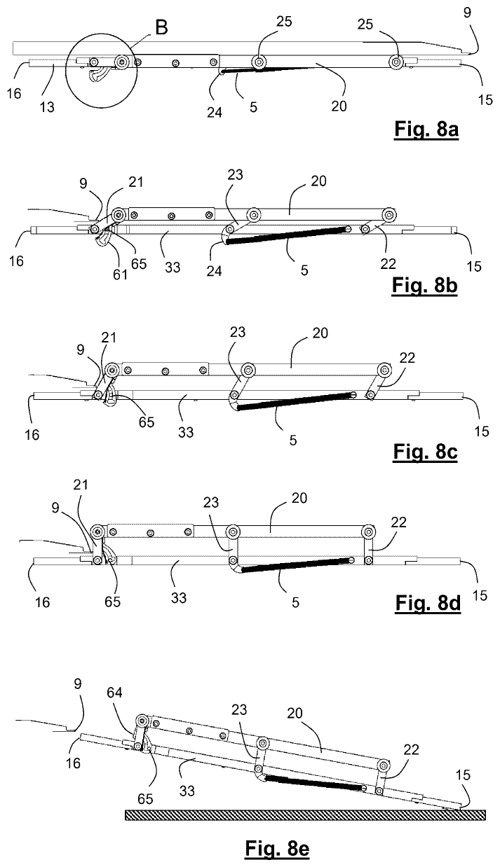

The side barrier 2 of the modular assembly 100 is capable of moving between a folded position, depicted for example in FIG. 4, in which the side barrier 2 does not protrude, or protrudes a minimum distance, with respect to the upper face 31 of the barrier support 3, and an unfolded position, depicted in FIGS. 2 and 3, in which the side barrier 2 protrudes a maximum distance (significantly greater than the minimum distance) above the upper face 31 of the barrier support 3. This minimum distance is such that the platform 11 is concealed below the floor of the vehicle in the resting position (see FIG. 8a), while the maximum distance does not allow it.

Whether the side barrier 2 adopts one position or the other (the end folded and unfolded positions, and the intermediate positions), depends on whether the entire side barrier 2 has exited outside, beyond the floor edge 9 when the platform 11 is moved between the resting position and the platform operating position. Specifically, in the side barrier 2 of the depicted modular assembly 100, the position of the side barrier 2 at each point in time depends on whether the rear end of the side barrier 2 that is closest to the floor edge 9 of the vehicle when the modular assembly 100 is assembled is inserted into a space below the floor of the vehicle or is outside said space when the platform 11 of the ramp 1 is moved between the resting position and the platform operating position.

As shown in the drawings, the side barrier 2 forms a hinged parallelogram structure together with the outer side face 33 of the support 3. The depicted side barrier 2 comprises a main bar 20 arranged parallel to the outer side face 33 of the support 3, a first arm 21, a second arm 22 and a third arm 23, arranged parallel to each other. Each of the arms 21, 22, 23 is provided with a first joint with the main bar 20 and a second joint with the outer side face 33 of the support 3. In the unfolded position, the first joints are at the upper ends of the arms and the second joints at the lower ends. In the unfolded position of the side barrier 2, the main bar 20 is positioned above the upper face 31 of the barrier support 3, and in the folded position, the main bar 20 is arranged flush with the upper face 31 of the barrier support 3. Specifically, in the unfolded position of the side barrier 2, the main bar 20 is positioned above the upper face 31 of the support 3 and the arms 21, 22 and 23 are arranged in a direction perpendicular to the main bar 20, whereas in the folded position of the side barrier 2, the arms 21, 22 and 23 are arranged in a direction almost parallel to the main bar 20, folded down with respect to the outer side face 33 of the support 3. In particular, according to the drawings, in the folded position, the arms 21, 22 and 23 are arranged concealed between the plane of the main bar 20 and the outer side face 33 of the support 3.

The third arm 23 has the particular feature that at its lower end it extends in an appendage 24 beyond the articulation of the arm with the outer lateral face 33. This appendage 24 is used to connect to the end of a traction spring which is connected at the other end thereof to a point on the outer side face 33 of the support 3 located at a point between the joints of the second and third arms 22, 23 with the outer side face 33, being closer to the second arm 22 than to the third arm 23. This traction spring is a biasing means 5 by which the side barrier 2 is biased to its unfolded position as the traction spring acts by pulling the appendage 24 of the third arm 23, causing the third arm 23 to be maintained in a position perpendicular to the upper surface 31 of the support 3 in the absence of other forces (see FIGS. 3, 5-7, 8d, 8e and 12-14) and hence the main bar 20 of the side barrier 2 is maintained in the maximum height position raised above the plane of the upper face 31 of the support 3 of the modular assembly 100.

There are other possible arrangements of biasing means for biasing the side barrier 2 in the unfolded position, which are not shown in the figures, such as placing push straps or traction springs between the outer side face 33 and the main bar 20 itself.

In this way, the side barrier 2 adopts the unfolded position whenever the first arm 21, which is the one located at the rear end of the side barrier 2, has completely exited the interior of the space below the floor of the vehicle, when it has completely exited beyond the floor edge 9 of the vehicle, as shown in the sequence of FIG. 8, which will be explained in detail below.

Thus, the modular assembly 100 is simple and quick to install on almost any side edge 13, 14 of a retractable platform 11, as the support 3 only needs to be screwed to said edge. A further advantage of the modularity of this modular side barrier 2 assembly 100 is that if the side barrier 2 accidentally gets stuck in the unfolded position or in a semi-unfolded or partially unfolded position (between the end folded position and the end unfolded position), preventing it from folding automatically during the retraction movement of the platform 11, as it cannot fit in the space below the floor of the vehicle due to its height, the driver or operator can easily unscrew the support 3 and take the entire modular assembly 100 into the cab, and the platform 11 can then be fully inserted into the interior of the vehicle and continue to move. If the driver or operator has enough time, and has a spare modular assembly 100 in the cab, they can screw on the support 3 of the new modular assembly 100 comprising a side barrier 2 in perfect condition.

Advantageously, the side barrier 2 comprises, at the ends of the hinge shafts by which the arms 21, 22 and 23 are hinged to the main bar 20, respective wheels 25 the contour of which protrudes from the upper edge of the main bar 20. These wheels 25 are made of an anti-friction material to facilitate the smooth sliding of the main bar 20 by rolling below the floor of the vehicle, avoiding any friction of the lower surface of the floor with any component of the side barrier 2. At the attachment thereof with the shaft of rotation of the wheels 25, the wheels 25 are preferably made of a polyamide type to rub against the shaft of the wheel 25 and cause the wheels 25 to rotate as the platform 11 moves relative to the surface below the floor of the vehicle (the roof of the framework 8 if present).

Another important feature of the modular assembly 100, and especially of the side barrier 2 thereof, is that the side barrier 2 comprises a locking device 6 for locking the barrier in the unfolded position when the side barrier 2 is completely outside the interior of the vehicle, and unlocking it to initiate its folding when it starts to be inserted into the interior of the vehicle. It is important that when the side barrier 2 has moved from the unfolded position to the folded position, the side barrier 2 remains stable in the unfolded position when it is completely out from below the floor of the vehicle and above all, to prevent accidents when passengers travel over the platform 11.

The locking device 6 is shown in detail in FIGS. 7 and 14 in a locked position with the side barrier 2 in the unfolded position, in FIGS. 10 and 11 in a non-locking or unlocked position, when the side barrier 2 is in the folded position, and in FIG. 13 in a non-locking or unlocked position with the side barrier 2 in the unfolded position.

It can be seen that the locking device 6 comprises: a locking platen 61, a pivot 65, and a locking biasing means 66.

The locking platen 61 is hinged to the hinge shaft of the first arm 21 with the side barrier 2 of the first arm 21. It is recalled that the first arm 21 is determined as it is the arm that is arranged closest to the rear face 36 of the support 3 and it is the arm that is hinged at the rear end of the main bar 20. The rear components are the closest to the vehicle. The locking platen 61 is arranged between the plane in which the first arm 21 moves and the plane of the outer side face 33 of the support 3. The locking platen 61 is provided with a slot 62 configured mostly with a path of a circular arc (almost equivalent to a quarter of a circumference), the arc being concentric with respect to the centre of the joint of the first arm 21 with the outer side face 33. The slot 62 extends at its end away from the joint of the first arm 21 with the main rod 20 in a locking section 63 which protrudes from the rest of the path of the slot 62 in a direction away from the joint of the first arm 21 with the outer side face 33 of the support 3.

In turn, it can be seen that a pivot 65 protrudes perpendicularly from the outer face 33 of the support 3 and that the pivot 65 is arranged at any time inside the slot 62. The locking system 6 is configured such that when the pivot 65 is inside the locking section 63 of the slot 62, the side barrier 2 is in the locked position in which it is locked in its unfolded position, as shown in FIGS. 7 and 14.

In any other position occupied by the pivot 65 inside the slot 62 other than the locking section 63, the side barrier 2 is in an unlocked position, either in an unfolded position of the side barrier 2, that is, when the side barrier 2 is about to enter or exit the space below the floor (FIG. 8d), or in a folded barrier position (FIG. 8a) when the side barrier 2 is completely below the floor of the vehicle, or in a partially folded position (FIGS. 8b and 8c).

As for the locking biasing means 66, it is attached on the one hand to the first arm 21 and on the other hand to the locking platen 61 that it biases so that the locking platen 61 is in the position where the pivot 65 is inside the locking section 63 of the slot 62. The locking biasing means 66 is a strap attached at a first end to a portion of the first arm 21 close to (in the vicinity of) the joint of said arm 21 with the main bar 20 (see attaching means 67 in FIGS. 10 and 11), and attached at the other end thereof to the locking platen 61 to a portion in the vicinity of or close to the end of the slot 62 that extends into the locking section 63. In FIGS. 13 and 14, this strap and the manner in which one end thereof is connected or attached by means of engagement in an engagement hole 68 in the locking platen 61 is clearly visible. FIG. 10 shows the strap in an exploded position with respect to the locking platen 61 in order to be able to better see the engagement hole 68, and in FIG. 11 the strap has been schematically represented by a dotted line.

The change from locked to unlocked state is achieved due to the fact that the locking platen 61 has an unlocking edge 64 located opposite the edge of the locking platen 62 which is closer to the locking section 63 of the slot 62. In the locked position, in which the side barrier 2 is locked in its unfolded position, the unlocking edge 64 protrudes from behind the first arm 21 extending in the direction towards the rear face 36 of the support 3, the unlocking edge 64 being on one side of the first arm 21 and the pivot 65 on the opposite side of the first arm 21 in said locked position. This unlocking is possible because the locking biasing means 66 is configured so that when a certain force is exerted on the unlocking edge 64, the locking biasing means 66 allows the locking platen 61 to rotate about the hinge shaft of the first arm 21 with the main bar 20 to an unlocked unfolded position of the side barrier 2 where the pivot 65 is outside the locking section 63 of the slot 62.

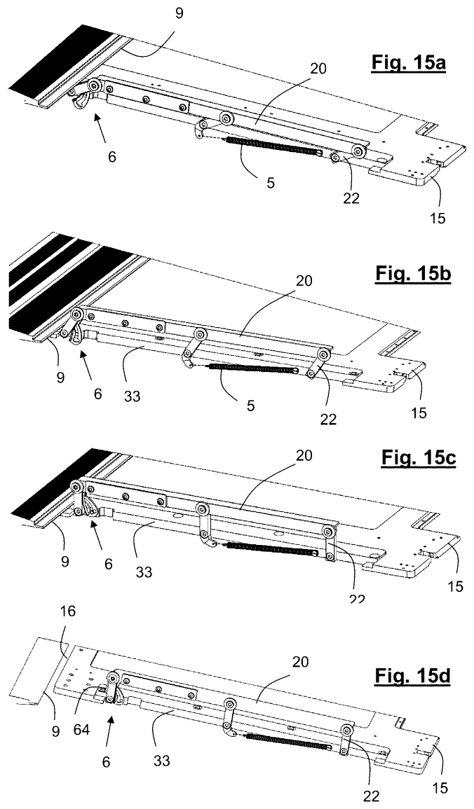

The unlocking edge 64 is located in an area of the locking platen 61 that is susceptible to strike against the floor edge 9 of the vehicle below which the platform 11 is installed when the rear edge 16 of the platform 11 starts to be inserted below the floor when leaving the platform operating position to move towards the resting position, which would be the case when moving from the situation shown in FIGS. 8e to 8a, or FIGS. 15d to 15a. In particular, in FIGS. 8e and 15d show how the unlocking edge 64 protrudes from behind the first arm 21 and it is this unlocking edge 64 that constitutes the first part of the side barrier 2 that meets the edge of the floor 9 when the platform 11 is to be inserted below the floor when it is to be concealed.

The locking biasing means 66 is configured so that the value of the force that enables unlocking is at least the value of the thrust that the unlocking edge 64 receives from the floor edge 9 of the vehicle when the rear edge 16 of the platform 11 begins to be inserted below the floor as it leaves the platform operating position and moves towards the resting position.

It must be noted that the described modular assembly 100 provides the advantages associated with the modularity thereof, which allow a simple and quick placement on the side edges 13 and 14 of the ramp 1 platforms 11 as described or of the bridge plate platforms 11, and consequently, also a quick disassembly when the situation requires it.

However, it is also noted that the side barrier 2 itself with the locking device 6 thereof provides advantages in the operation of the folding and unfolding of the side barrier 2, which only depends on whether or not the side barrier 2 has completely exited its housing below the floor 9 of the vehicle, and that this type of side barrier 2, and the biasing means 5, could be applied directly to any side edge of a ramp 1 or bridge plate platform 11. That is, only the side barrier 2, and in particular the joints of the arms 21, 22 and 23 at the ends opposite the joints of the arms 21, 22 and 23 to the main bar 20 would need to be assembled on the side edge 13 or 14 itself of the platform 11, rather than hinging the arms to the outer side face 33 of the support 3 of the modular assembly 100. The biasing means 5, in this case the traction spring, would also be linked to a point of the side edge 13 or 14 of the platform 11 between the joints of the third and second arms 23 and 22, and at the other end thereof to the appendage 24 of the third arm 23. Thus, if instead of assembling the side barrier 2 on the support 3, it were to be assembled directly on the side edge 13 or 14 of the platform 11, any reference described in the modular assembly 100 in reference to a face of the support 3, would become in reference to a corresponding edge, face or surface belonging to the platform 11 itself, since the support 3 has been defined by its faces and edges which are respectively parallel to the faces and edges of the platform 11.

1. A modular side barrier assembly for a retractable platform of a ramp or a bridge plate for people to access a vehicle, the platform extendible from a resting position, in which the platform below a floor of the vehicle, to a platform operating position, in which the platform extends from a floor edge of the vehicle to a surface from which people access the vehicle, the modular assembly comprising:
a barrier support configured as an oblong platen, the support including an upper face, a lower face, an outer side face, an inner side face, a front face and a rear face;
removable fastening means for fastening the barrier support to at least one side edge of the platform; and
a side barrier to move between a folded position and an unfolded position, in the folded position the side barrier protrudes no more than a first distance from the upper face of the barrier support, the first distance to allow the platform to be concealed below the floor of the vehicle in the rest position of the platform, and in the unfolded position the side barrier protrudes a second distance above the upper face of the barrier support, the second distance being greater than the first distance.

2. The modular side barrier assembly according to claim 1, wherein the removable fastening means include at least two screws, the barrier support includes at least two corresponding holes to respectively receive the two screws.

3. The modular side barrier assembly according to claim 1, wherein the side barrier forms a hinged parallelogram structure together with the outer side face of the support, the side barrier includes a main bar, arranged parallel to the outer side face of the support, and at least two arms arranged parallel to each other, each arm having a first joint with the main bar and a second joint with the outer side face of the support, and in the unfolded position of the side barrier, the main bar is located above the upper face of the barrier support and the at least two arms are arranged in a direction perpendicular to the main bar, and in the folded position of the side barrier the at least two arms are folded down with respect to the outer side face.

4. The modular side barrier assembly according to claim 3, wherein the side barrier includes at least one means for biasing the side barrier to its unfolded position.

5. The modular side barrier assembly according to claim 4, wherein the biasing means includes at least one of a traction spring or a push strap.

6. The modular side barrier assembly according to claim 4, wherein the at least two arms include first and second arms, the side barrier includes a third arm between and parallel to the first arm and the second arm, the third arm including a first joint with the main bar and a second joint with the outer side face of the support.

7. The modular side barrier assembly according to claim 6, wherein the third arm extends in an appendage beyond its hinge on the outer side face of the support, and the biasing means is between the appendage and a point on the outer side face, the biasing means to bias the side barrier to its unfolded position via the third arm.

8. The modular side barrier assembly according to claim 3, wherein the side barrier includes respective hinge shafts to hingedly attach the arms of the side barrier to the main bar, and including respective wheels at corresponding ends of the hinge shafts, contours of the wheels to protrude from the upper edge of the main bar.

9. The modular side barrier assembly according to claim 8, wherein the wheels include an anti-friction material.

10. The modular side barrier assembly according to claim 1, wherein the side barrier includes a locking device to lock the side barrier in the unfolded position when the side barrier is outside the vehicle, the locking device to unlock the side barrier to permit its folding when inserted into the interior of the vehicle.

11. The modular side barrier assembly according to claim 4 including a locking device, the locking device includes:
a locking platen hinged to the hinge shaft with the side barrier of the first arm which is arranged closest to the rear face of the support, the first arm being hinged at the rear end of the main bar, the locking platen between a plane in which the first arm moves and a plane of the outer side face of the support, the locking platen having a slot aligned with a path of a concentric circular arc with respect to a centre of the hinge of the first arm, the outer side face and the slot extending from the hinge of the first arm with a locking section of the slot protruding from the the path of the slot in a direction away from an articulation of the first arm with the outer side face;
a pivot protruding from the outer face of the support in a direction perpendicular thereto, the pivot inside the slot when the pivot is inside the locking section of the slot, the side barrier is in the locking position in which it is locked in its unfolded position; and
a locking biasing means attached to the first arm and to the locking platen, the locking biasing means to bias the locking platen is in the position where the pivot is inside the locking section of the slot.

12. The modular side barrier assembly according to claim 11, wherein the locking platen has an unlocking edge located opposite the edge of the locking platen which is closest to the locking section of the slot, and in the locked position where the side barrier is locked in its unfolded position, the unlocking edge protrudes from behind the first arm extending in the direction towards the rear face of the support, the unlocking edge being on one side of the first arm and the pivot on the opposite side of the first arm in the locked position, and when a certain force is exerted on the unlocking edge, the locking biasing means allows the locking platen to rotate about the hinge shaft of the first arm with the main bar to an unlocked unfolded position of the side barrier where the pivot is outside the locking section of the slot.

13. The modular side barrier assembly according to claim 12, wherein the locking biasing means includes a strap attached at one end to a portion of the first arm in a vicinity of the articulation of the first arm with the main bar, and attached at another end to the locking platen to a portion located in the vicinity of locking section.

14. The modular side barrier assembly according to claim 12, wherein the unlocking edge is in an area of the locking platen that is susceptible to strike against the floor edge of the vehicle below which the platform is installed when the platform starts to be inserted below the floor when leaving the platform operating position to move towards the resting position.

15. The modular side barrier assembly according to claim 14, wherein a force of the biasing means is at least as large as a thrust that the unlocking edge receives from the floor edge of the vehicle when the platform begins to be inserted below the floor as it leaves the platform operating position and moves towards the resting position.

16. (canceled)
